(19) United States
(12) Patent Application Publication
(10) Pub. No.: US 2018/0066454 A1
(43) Pub. Date: Mar. 8, 2018

(54) ANTI-TOPPLING DRAWER CHEST

(71) Applicant: Sen LU, Guangdong (CN)

(72) Inventor: Sen LU, Guangdong (CN)

(21) Appl. No.: 15/279,364

(22) Filed: Sep. 28, 2016

(30) Foreign Application Priority Data
Sep. 5, 2016 (CN) 201621037410.4

(51) Int. Cl. E05B 65/46; A47B 67/04

(52) U.S. Cl. CPC E05B 65/463; A47B 67/04

(57) ABSTRACT

An anti-toppling drawer chest comprises a plurality of drawers arranged on a chest body. An anti-toppling interlocking mechanism is arranged between the side wall of the chest body and the drawers and comprises fixing pieces, a sliding rod and stop blocks, wherein the fixing pieces are installed on the side wall of the chest body, the sliding rod is installed between the fixing pieces and the side wall of the chest body, the stop blocks are installed on the side walls of the drawers, oblique slideways are arranged on the stop blocks, and the sliding rod and clamping tenons slide along the oblique slideways when the drawers are pulled out and pushed back. According to the anti-toppling drawer chest of the invention, the function that a single drawer is pulled out and the other drawers are locked is achieved.

### BACKGROUND OF THE INVENTION

The invention relates to furniture and office drawer chests, in particular to an anti-toppling drawer chest.

A three-drawer chest or a five-drawer chest or a multi-layer drawer chest with drawers of other numbers is of a stacking structure so that more articles can be stored, and the drawer chests are more and more popular in families and office places; particularly in families, for increasing the area utilization rate, the drawer chests is the first choice. Since the height of the multi-layer drawer chest is large, when drawers are pulled out, if multiple drawers are pulled out at a time, the drawer chest is affected by the unbalanced gravity of the drawers, and the whole drawer chest can topple quite easily. Particularly, infants and children at small ages in families usually take drawer pulling-out as a playing way, and if in-time attendance is not given at the moment, the problem of toppling of the drawer chest occurs quite easily, and accordingly the children are injured.

For improving the safety performance of drawer chests, mechanical interlocking mechanisms are installed on part of the drawer chests, so that the effect that only one drawer can be pulled out at a time is guaranteed, another drawer can be pulled out only after the drawer which is pulled out currently is pushed back, and accordingly an anti-toppling function is achieved. However, the existing mechanical interlocking mechanisms are generally quite complicated in structure, and the installation cost is increased.

### BRIEF SUMMARY OF THE INVENTION

For solving the technical problems, the invention provides an anti-toppling drawer chest which is easy to install and simple in structure.

The following scheme is adopted by the invention for solving the technical problems:

An anti-toppling drawer chest comprises a plurality of drawers which are arranged on a chest body from top to bottom, an anti-toppling interlocking mechanism is arranged between the side wall of the chest body and the drawers, and the anti-toppling interlocking mechanism comprises:
fixing pieces, wherein clamping grooves are formed in the fixing pieces, the fixing pieces are fixedly installed on the side wall of the chest body, and gaps are formed between the fixing pieces and the side wall of the chest body;
a sliding rod, wherein the sliding rod is movably installed in the gaps between the fixing pieces and the side wall of the chest body in an inserted mode, clamping tenons are arranged on the sliding rod, and the clamping tenons are movably installed in the clamping grooves of the fixing pieces in an inserted mode;
stop blocks, wherein the stop blocks are fixedly installed on the side walls of the drawers, oblique slideways are arranged on the stop blocks, the inlet ends of the oblique slideways face the front ends of the drawers, the outlet ends of the oblique slideways face the rear ends of the drawers, and the sliding rod and the clamping tenons slide along the oblique slideways when the drawers are pulled out and pushed back;
when all the drawers are closed, the inlet ends of the oblique slideways on the stop blocks right face the clamping tenons on the sliding rod; when one drawer is pulled out, the lower side walls of the inlet ends of the oblique slideways on the stop blocks on the other drawers right face the corresponding clamping tenons on the sliding rod, so that the clamping tenons are prevented from entering the oblique slideways.

The clamping groove of each fixing piece comprises clamping sections and moving sections, and the clamping sections are in smooth transition with the moving sections.

Sliding grooves are further formed in the fixing pieces, and the sliding rod is installed in the sliding grooves in an inserted mode.

At least two fixing pieces are arranged and correspond to the upper end and the lower end of the sliding rod respectively.

An extension end is arranged on each stop block, and the extension end is formed by extending the portion, located above the inlet end of the correspondingly oblique slideway, of the side wall.

The stop blocks are locked to the side walls of the drawers through screws, and the fixing pieces are locked to the side wall of the chest body through screws.

The installation direction of the fixing piece at the uppermost end of the side wall of the chest body is opposite to the installation direction of the fixing piece at the lowermost end of the side wall of the chest body.

Both the stop blocks and the fixing pieces are made of plastic materials.

The clamping tenons on the sliding rod are cylindrical.

An operating clamping tenon is arranged at the top of the sliding rod.

According to the utility mode, assembly is convenient, the number of components is small, the function that a single drawer is pulled out and the other drawers are locked is achieved, and the structure is quite simple.

### BRIEF DESCRIPTION OF THE DRAWINGS

FIG. 1 is a side-view structural schematic diagram of the invention with a chest body being removed and drawers being in the closed state;

FIG. 2 is a space structural schematic diagram of a stop block of the invention;

FIG. 3 is a front-view structural schematic diagram of a fixing piece of the invention;

FIG. 4 is a space structural schematic diagram of the invention after the fixing piece and a sliding rod are assembled;

FIG. 5 is a schematic diagram of one drawer in a pulled-out state of the invention;

FIG. 6 is an enlarged schematic diagram of an A portion of the invention.

### DETAILED DESCRIPTION OF THE INVENTION

For the convenient understanding of those skilled in the field, further description of the invention is given with accompanying drawings as follows.

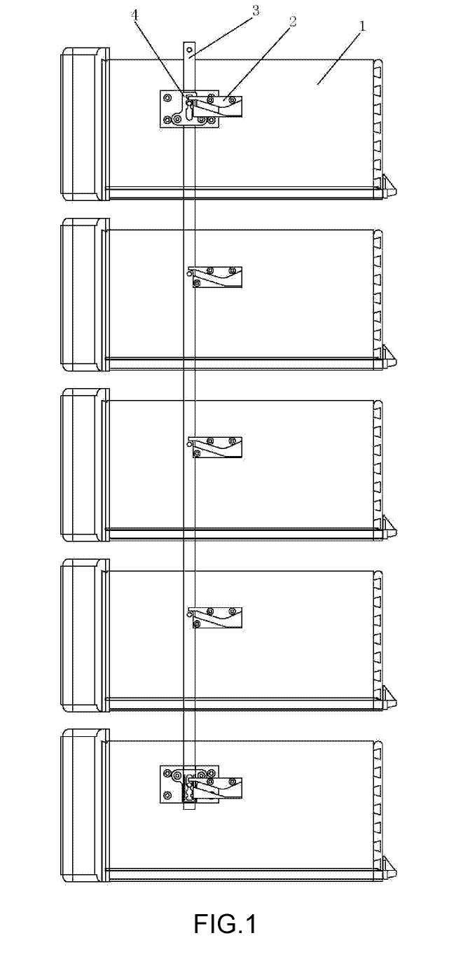

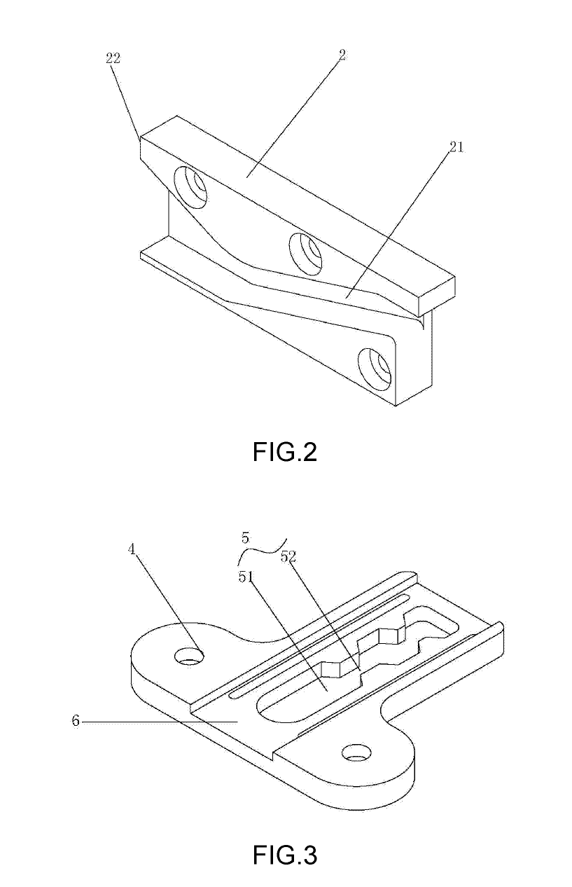

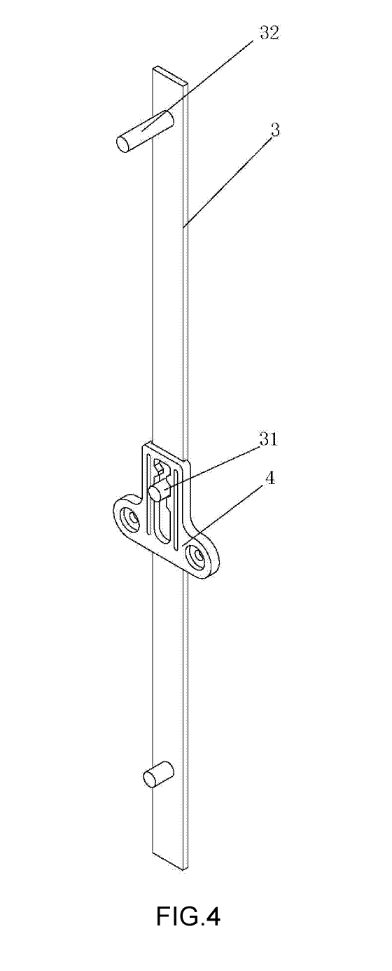

As is shown in FIGS. 1-4, the invention discloses an anti-toppling drawer chest which comprises a plurality of drawers 1 which are arranged on a chest body from top to bottom, and an anti-toppling interlocking mechanism is arranged between the side wall of the chest body and the drawers; the anti-toppling interlocking mechanism comprises fixing pieces 4, a sliding rod 3 and stop blocks 2, wherein clamping grooves 5 are formed in the fixing pieces 4, the fixing pieces are fixedly installed on the side wall of the chest body, and gaps are formed between the fixing pieces and the side wall of the chest body; the sliding rod 3 is movably installed in the gaps between the fixing pieces 4 and the side wall of the chest body in an inserted mode, clamping tenons 31 are arranged on the sliding rod 3, and the clamping tenons 31 are movably installed in the clamping grooves 5 of the fixing pieces 4 in an inserted mode; an operating clamping tenon 32 is further arranged at the top of the sliding rod and used for maintaining and removing the drawers; when one drawer is removed, another drawer can be removed only by forcibly pulling the sliding rod upwards manually through the operating clamping tenon 32, and all the drawers can be removed by repeating the step; the stop blocks 2 are fixedly installed on the side walls of the drawers 1, oblique slideways 21 are arranged on the stop blocks 2, the inlet ends of the oblique slideways 21 face the front ends of the drawers, the outlet ends of the oblique slideways 21 face the rear ends of the drawers, and the sliding rod and the clamping tenons slide along the oblique slideways when the drawers are pulled out and pushed back; when all the drawers are closed, the inlet ends of the oblique slideways on the stop blocks right face the clamping tenons on the sliding rod; when one drawer is pulled out, the lower side walls of the inlet ends of the oblique slideways on the stop blocks on the other drawers right face the corresponding clamping tenons on the sliding rod, so that the clamping tenons are prevented from entering the oblique slideways, and the effect that only one drawer can be pulled out at a time is guaranteed. The clamping tenons are generally cylindrical and are preferably made of iron materials.

For the oblique slideways of the stop blocks 2, the inlet ends can be higher than the outlet ends, and the outlet ends can also be higher than the inlet ends. In the embodiment, the inlet ends of the oblique slideways are higher than the outlet ends of the oblique slideways so that the sliding rod can be lowered by a certain distance after entering the oblique slideways from the inlet ends and coming out of the oblique slideways from the outlet ends.

The clamping groove 5 of each fixing piece 4 comprises clamping sections 52 and moving sections 51, and the clamping sections 52 are in smooth transition with the moving sections 51. Generally, multiple clamping sections and multiple moving sections are arranged, and the clamping sections are narrower than the moving sections. For example, in the embodiment, three moving sections are arranged, and two clamping sections are arranged between the three moving sections. The clamping tenons are limited by the clamping sections on the moving sections, and only when force is applied to the clamping tenons, the clamping tenons can reach another moving section from one moving section by penetrating through the correspondingly clamping section.

Sliding grooves 6 are further formed in the fixing pieces 4, the sliding rod 3 is installed in the sliding grooves 6 in an inserted mode, and thus the sliding rod can better move up and down along the fixing pieces.

At least two fixing pieces are arranged and correspond to the upper end and the lower end of the sliding rod respectively. The number of the fixing pieces can be flexibly selected according to the number of the drawers. For example, a three-drawer chest can be provided with two fixing pieces, and for guaranteeing the stability, a five-drawer chest or a six-drawer chest can be provided with three fixing pieces, namely the upper portion, the middle portion and the lower portion are each provided with one fixing piece. A higher drawer chest can be provided with fixing pieces of other numbers. The installation direction of the fixing piece at the uppermost end of the side wall of the chest body is opposite to the installation direction of the fixing piece at the lowermost end of the side wall of the chest body, so that the phenomenon that the sliding rod gets stuck due to excessive sliding is prevented, and the effect that the sliding rod moves up and down more smoothly can be guaranteed.

An extension end 22 is arranged on each stop block 2, and the extension end 22 is formed by extending the portion, located above the inlet end of the corresponding oblique slideway 21, of the side wall. The extension ends can be used for blocking the clamping tenons on the sliding rod, so that the clamping tenons are blocked by the extension ends and cannot move upwards; the extension ends can also have a guiding function so that the clamping tenons can better enter the oblique slideways on the stop blocks.

The stop blocks are locked to the side walls of the drawers through screws, and the fixing pieces are locked to the side wall of the chest body through screws, so that mounting and dismounting are facilitated, and later-stage maintenance is convenient.

Both the stop blocks and the fixing pieces are made of plastic materials and have certain elasticity, and high noise is prevented from being generated.

In the invention, as is shown in FIG. 1 which is the schematic diagram of all the drawers in the closed state, five drawers are arranged in the chest body in total, two fixing pieces are arranged in total, one fixing piece is installed in the area, corresponding to the drawer in the uppermost layer, of the side wall of the chest body, and the other fixing piece is installed in the area, corresponding to the drawer on the lowermost layer, of the side wall of the chest body. At the moment, the clamping tenons on the sliding rod are located in the clamping grooves in the fixing pieces and particularly located in the moving sections of the clamping groves and right face the inlet ends of the oblique slideways on the stop blocks, any drawer can be pulled out, and all the drawers are in the unlocked state.

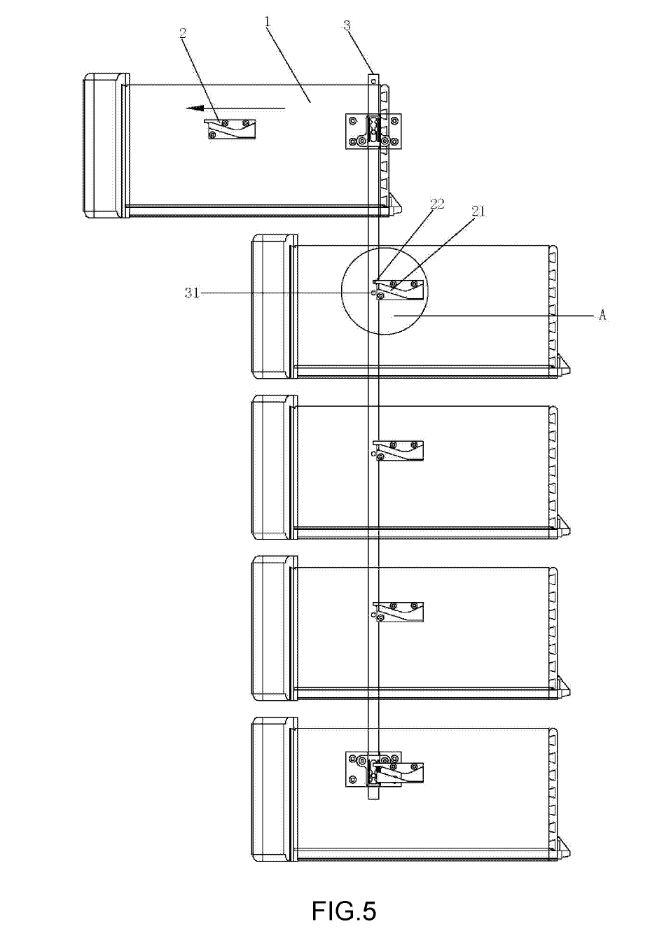

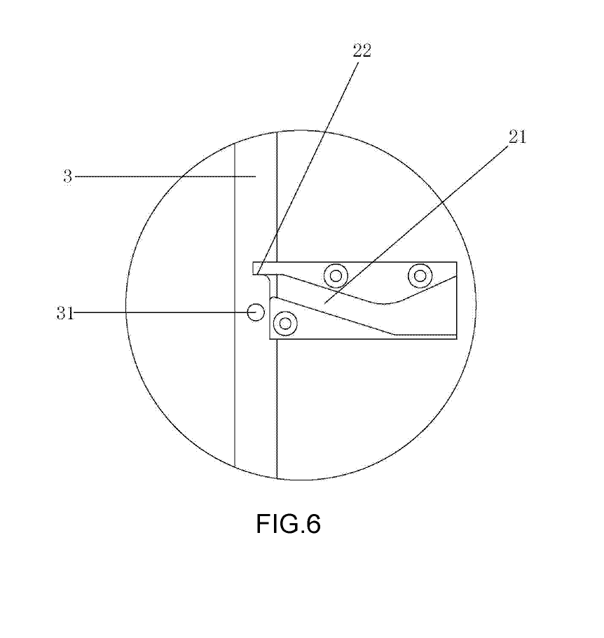

As is shown in FIG. 5 and FIG. 6, the drawer on the uppermost layer is pulled out, and in the process of pulling out the drawer, the clamping tenons on the sliding rod enter the oblique slideways and slide along the oblique slideways, the sliding rod is driven to move downwards by a certain distance along with the sliding of the oblique slideways which incline downwards, and the sliding rod moves downwards in the gaps between the side wall of the chest body and the fixing pieces. After the drawer is completely pulled out, the stop blocks move across the fixing pieces at the moment, and the clamping tenons on the sliding rod slide out from the outlet ends of the oblique slideways of the fixing pieces; since the outlet ends of the oblique slideways are lower than the inlet ends of the oblique slideways, the sliding rod is made to move downwards by a certain distance relative to the sliding rod before entering the oblique slideways, the positions of the other clamping tenons on the sliding rods are also lowered by certain distances, the clamping tenons which originally right face the inlet ends of the oblique slideways are made to right face the side walls of the inlet ends of the oblique slideways after being lowered, and accordingly the clamping tenons are blocked by the side walls and cannot enter the oblique slideways. At the moment, even if the drawers are pulled with external force, the drawers cannot be pulled out outwards due to the fact that the side walls of the stop blocks on the drawers and the clamping tenons are mutually blocked, so that the effect that only one drawer can be pulled out and the other drawers are in the locked state is guaranteed, the safety is guaranteed, and thus the situation that the drawer chest topples due to the fact that the front gravity and the rear gravity are out of control when multiple drawers are pulled out at the same time is avoided.

What needs to be pointed out is that the invention is not limited to the foregoing description, and any obvious substitutions not deviating from the creative design of the invention are all within the protection scope of the invention.

What is claimed is:

1. An anti-toppling drawer chest, comprising a plurality of drawers arranged on a chest body from top to bottom, wherein an anti-toppling interlocking mechanism is arranged between the side wall of the chest body and the drawers; characterized in that the anti-toppling interlocking mechanism comprises:
fixing pieces, wherein clamping grooves are formed in the fixing pieces, the fixing pieces are fixedly installed on the side wall of the chest body, and gaps are formed between the fixing pieces and the side wall of the chest body;
a sliding rod, wherein the sliding rod is movably installed in the gaps between the fixing pieces and the side wall of the chest body in an inserted mode, clamping tenons are arranged on the sliding rod, and the clamping tenons are movably installed in the clamping grooves of the fixing pieces in an inserted mode;
stop blocks, wherein the stop blocks are fixedly installed on the side walls of the drawers, oblique slideways are arranged on the stop blocks, the inlet ends of the oblique slideways face the front ends of the drawers, the outlet ends of the oblique slideways face the rear ends of the drawers, and the sliding rod and the clamping tenons slide along the oblique slideways when the drawers are pulled out and pushed back;
when all the drawers are closed, the inlet ends of the oblique slideways on the stop blocks right face the clamping tenons on the sliding rod; when one drawer is pulled out, the lower side walls of the inlet ends of the oblique slideways on the stop blocks on the other drawers right face the corresponding clamping tenons on the sliding rod, so that the clamping tenons are prevented from entering the oblique slideways.

2. The anti-toppling drawer chest according to claim 1, characterized in that the clamping groove of each fixing piece comprises clamping sections and moving sections, and the clamping sections are in smooth transition with the moving sections.

3. The anti-toppling drawer chest according to claim 2, characterized in that sliding grooves are further formed in the fixing pieces, and the sliding rod is installed in the sliding grooves in an inserted mode.

4. The anti-toppling drawer chest according to claim 3, characterized in that at least two fixing pieces are arranged and correspond to the upper end and the lower end of the sliding rod respectively.

5. The anti-toppling drawer chest according to claim 4, characterized in that an extension end is arranged on each stop block, and the extension end is formed by extending the portion, located above the inlet end of the correspondingly oblique slideway, of the side wall.

6. The anti-toppling drawer chest according to claim 5, characterized in that the stop blocks are locked to the side walls of the drawers through screws, and the fixing pieces are locked to the side wall of the chest body through screws.

7. The anti-toppling drawer chest according to claim 6, characterized in that the installation direction of the fixing piece at the uppermost end of the side wall of the chest body is opposite to the installation direction of the fixing piece at the lowermost end of the side wall of the chest body.

8. The anti-toppling drawer chest according to claim 7, characterized in that both the stop blocks and the fixing pieces are made of plastic materials.

9. The anti-toppling drawer chest according to claim 8, characterized in that the clamping tenons on the sliding rod are cylindrical.

10. The anti-toppling drawer chest according to claim 9, characterized in that an operating clamping tenon is arranged at the top of the sliding rod.
